(19) United States
(12) Patent Application Publication
(10) Pub. No.: US 2012/0075173 A1
(43) Pub. Date: Mar. 29, 2012

(54) APPARATUS AND METHOD FOR USER INPUT

(75) Inventors: Daniel Lee Ashbrook, Santa Monica, CA (US); Aaron Toney, Issaquah, WA (US); Sean Michael White, Los Angeles, CA (US)

(73) Assignee: Nokia Corporation, Espoo (FI)

(21) Appl. No.: 12/889,243

(22) Filed: Sep. 23, 2010

(51) Int. Cl. G09G 5/00

(52) U.S. Cl. 345/156

(57) ABSTRACT

The present invention provides a method, apparatus, and computer program product for providing input to a user device by way of a device that is worn by a user. The method including receiving sensor information of a device configured to be worn by a user, determining a motion input indicated by the received information such that the motion input relates to motion of the device relative to the user, determining a function based at least in part on the motion input, and causing the function to be performed. The device may be configured to be worn on a device bearing part of the user and the motion input may relate to motion of the device relative to the device bearing part of the user. The device bearing part of the user may be a finger and the device may substantially encircle the finger.

### TECHNICAL FIELD

Example embodiments of the present invention generally relate to communication technology, and more particularly, relate to an apparatus and method for a user input device that is worn by a user.

### BACKGROUND

The modern communications era has brought about a tremendous expansion of wireline and wireless networks. Computer networks, television networks, and telephony networks are experiencing an unprecedented technological expansion fueled by consumer demands. Together with these expanding network capabilities and communication speeds, the devices that use these networks have experienced tremendous technological steps forward in capabilities, features, and user interface. Such devices may also use accessories such as remote input devices, Bluetooth™ headsets or wired headsets with limited functional capabilities. Devices communicating via these networks may be used for a wide variety of purposes including, among other things, Short Messaging Services (SMS), Instant Messaging (IM) service, E-mail, voice calls, music recording/playback, video recording/playback, and internet browsing. Such capabilities have made these devices very desirable for those wishing to stay in touch and make themselves available to others.

Hands free devices have increased in popularity through the advent of laws prohibiting hand-held mobile device usage when driving a vehicle and the desire of users to communicate without monopolizing the use of a hand. Such devices may include a wired headset that is physically connected to a mobile device or a Bluetooth™ headset that is connected to a mobile device through a wireless Personal Area Network connection. Additionally, Bluetooth™ vehicle accessories may allow a user to use a speaker and microphone within a vehicle to communicate over their mobile device. Such devices may enable the user of a mobile device to carry on a voice call through their mobile device without having to hold the device. Further, a Bluetooth™ headset or vehicle accessory may allow a user to carry on a voice call while the device remains in a purse, pocket, glove box, or other nearby location that may not be readily accessible. Such Bluetooth™ devices or headsets and vehicle accessories using other communications protocols may have limited functionality with respect to the device to which they are paired or synchronized. For example, a Bluetooth™ headset may be capable of adjusting the volume of a speaker, answering an incoming call, and ending a call.

While accessories exist that enable a user to carry on a phone call, listen to music, or provide voice commands, few accessories provide more than a limited amount of functionality with respect to the device to which they are paired.

### BRIEF SUMMARY

In general, example embodiments of the present invention provide an improved method of providing input to a user device. In particular, the method of example embodiments provide for receiving sensor information of a device configured to be worn by a user, determining a motion input indicated by the received information such that the motion input relates to motion of the device relative to the user, determining a function based at least in part on the motion input, and causing the function to be performed. The device may be configured to be worn on a device bearing part of the user and the motion input may relate to motion of the device relative to the device bearing part of the user. The device bearing part of the user may be a finger and the device may substantially encircle the finger. The motion input may include at least one of axial movement along a first axis which extends along the length of the device bearing part of the user, rotational movement about the first axis, or rotational movement about a second axis that is perpendicular to the first axis. The motion input may be detected using a sensor disposed on an inner surface of the device and the inner surface may include a surface that is in contact with the device bearing part of the user. The method may further include learning the motion input bay a learning process that includes receiving a motion input from the user where the motion input causes a motion of the device relative to the user, causing the motion input to be stored, and associating the motion input with a function. The function may include causing a command to be sent to another device.

According to another embodiment of the invention, an apparatus may be provided that includes at least one processor and at least one memory including computer program code where the at least one memory and the computer program code are configured to, with the at least one processor, cause the apparatus to receive sensor information of a device configured to be worn by a user, determine a relative motion input indicated by the received information, where the motion input relates to motion of the device relative to the user, determine a function based at least in part on the motion input, and causing the function to be performed. The device may be configured to be worn on a device bearing part of the user and the motion input may relate to motion of the device relative to the device bearing part of the user. The device bearing part of the user may be a finger and the device may substantially encircle the finger. The motion input may include at least one of axial movement along a first axis which extends along the length of the device bearing part of the user, rotational movement about the first axis, or rotational movement about a second axis which is perpendicular to the first axis. The motion input may be detected using a sensor disposed on an inner surface of the device and the inner surface may include a surface that is in contact with the device bearing part of the user. The at least one memory and the computer program code may further be configured to, with the at least one processor, cause the apparatus to receive a motion input from the user, where the motion input causes a motion of the device relative to the user, cause the motion input to be stored, and associate the motion input with a function. The function may include causing a command to be sent to another device.

According to still another embodiment of the invention, a computer program product is provided that comprises at least one computer-readable storage medium having computer-readable program instructions stored therein, the computer-readable program instructions including program code instructions for receiving sensor information of a device configured to be worn by a user, program code instructions for determining a motion input indicated by the received information, where the motion input relates to motion of the device relative to the user, program code instructions for determining a function based at least in part on the motion input, and program code instructions for causing the function to be performed. The device may be configured to be worn on a device bearing part of the user and the motion input may relate to motion of the device relative to the device bearing part of the user. The device bearing part of the user may be a finger and the device may substantially encircle the finger. The motion input may include at least one of axial movement along a first axis which extends along the length of the device bearing part of the user, rotational movement about the first axis, or rotational movement about a second axis that is perpendicular to the first axis. The motion input may be detected using a sensor disposed on an inner surface of the device and the inner surface may include a surface that is in contact with the device bearing part of the user. The computer executable program code instructions may further include program code instructions for receiving a motion input from the user, wherein the motion input causes a motion of the device relative to the user, program code instructions for causing the motion input to be stored, and program code instructions for associating the motion input with a function.

According to yet another embodiment of the invention, a means is provided for providing input to a user device. In particular, example embodiments provide means for receiving sensor information of a device configured to be worn by a user, means for determining a motion input indicated by the received information such that the motion input relates to motion of the device relative to the user, means for determining a function based at least in part on the motion input, and means for causing a function to be performed. The device may be configured to be worn on a device bearing part of the user and the motion input may relate to motion of the device relative to the device bearing part of the user. The device bearing part of the user may be a finger and the device may substantially encircle the finger. The motion input may include at least one of axial movement along a first axis which extends along the length of the device bearing part of the user, rotational movement about the first axis, and rotational movement about a second axis that is perpendicular to the first axis. The motion input may be detected using a sensor disposed on an inner surface of the device and the inner surface may include a surface that is in contact with the device bearing part of the user. The motion input may be learned through a learning process that includes means for receiving a motion input from the user where the motion input causes a motion of the device relative to the user, means for causing the motion input to be stored, and means for associating the motion input with a function. The function may include causing a command to be sent to another device.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile device according to an example embodiment of the present invention;

FIG. 2 is an illustration of a user input device according to an example embodiment of the present invention;

FIG. 3 is an illustration of an example embodiment of a user input device as worn by a user;

FIG. 4 is a cross-section view of an example embodiment of a user input device according to the present invention;

FIG. 5 is a cross-section view of another example embodiment of a user input device according to the present invention;

FIG. 6 is an illustration of a device bearing part of a user according to an example embodiment of the present invention;

FIG. 7 is an illustration of a user input device according to another example embodiment of the present invention;

FIG. 8 is an illustration of a user input device according to another example embodiment of the present invention;

FIG. 9 is an illustration of a user input device according to yet another example embodiment of the present invention;

FIG. 10 is a cross-section view of an example embodiment of a user input device according to the present invention;

FIG. 11 is a flow chart of a method for implementing example embodiments of the present invention; and

FIG. 12 is a flow chart of another method for implementing example embodiments of the present invention.

### DETAILED DESCRIPTION

Some example embodiments of the present invention will now be described more fully hereinafter with reference to the accompanying drawings, in which some, but not all embodiments of the invention are shown. Indeed, various embodiments of the invention may be embodied in many different forms and should not be construed as limited to the example embodiments set forth herein; rather, these example embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

While several embodiments of the user device may be illustrated and hereinafter described for purposes of example, other types of user devices, such as personal digital assistants (PDAs), pagers, mobile televisions, gaming devices, all types of computers (e.g., laptops or mobile computers), cameras, audio/video players, radio, global positioning system (GPS) devices, or any combination of the aforementioned, and other types of communication devices, may employ embodiments of the present invention. As described, the user device may include various means for performing one or more functions in accordance with embodiments of the present invention, including those more particularly shown and described herein. It should be understood, however, that a user device may include alternative means for performing one or more like functions, without departing from the spirit and scope of the present invention.

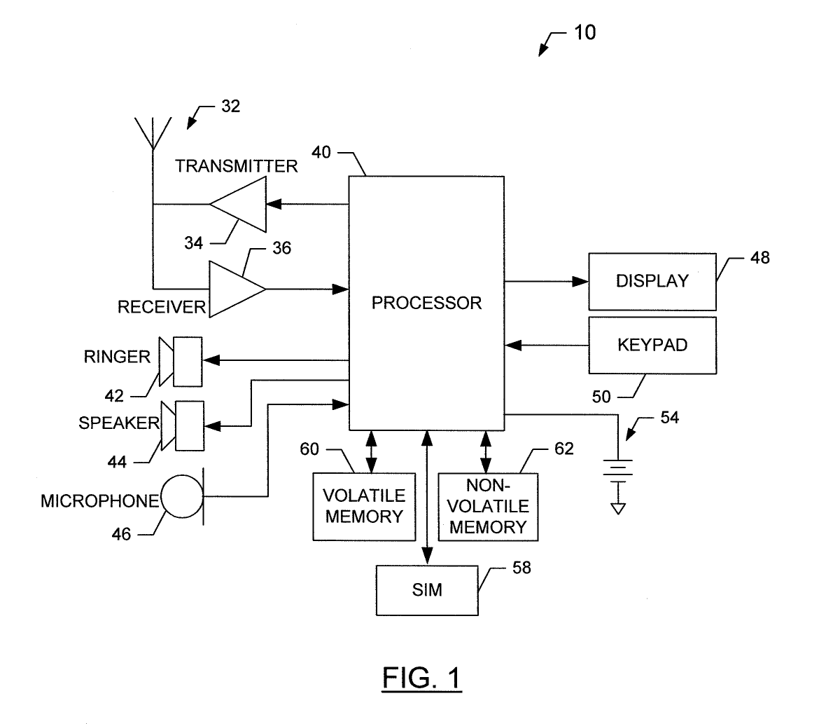

The user device 10 illustrated in FIG. 1 may include an antenna 32 (or multiple antennas) in operable communication with a transmitter 34 and a receiver 36. The user device may further include an apparatus, such as a processor 40, that provides signals to and receives signals from the transmitter and receiver, respectively. The signals may include signaling information in accordance with the air interface standard of the applicable cellular system, and/or may also include data corresponding to user speech, received data and/or user generated data. In this regard, the user device may be capable of operating with one or more air interface standards, communication protocols, modulation types, and access types. By way of illustration, the user device may be capable of operating in accordance with any of a number of first, second, third and/or fourth-generation communication protocols or the like. For example, the user device may be capable of operating in accordance with second-generation (2G) wireless communication protocols IS-136, GSM and IS-95, or with third-generation (3G) wireless communication protocols, such as UMTS, CDMA2000, wideband CDMA (WCDMA) and time division-synchronous CDMA (TD-SCDMA), with 3.9G wireless communication protocols such as E-UTRAN (evolved-UMTS terrestrial radio access network), with fourth-generation (4G) wireless communication protocols or the like. The user device may further be capable of communication over wireless Personal Area Networks (WPANs) such as IEEE 802.15, Bluetooth, low power versions of Bluetooth, infrared (IrDA), ultra wideband (UWB), Wibree, Zigbee or the like.

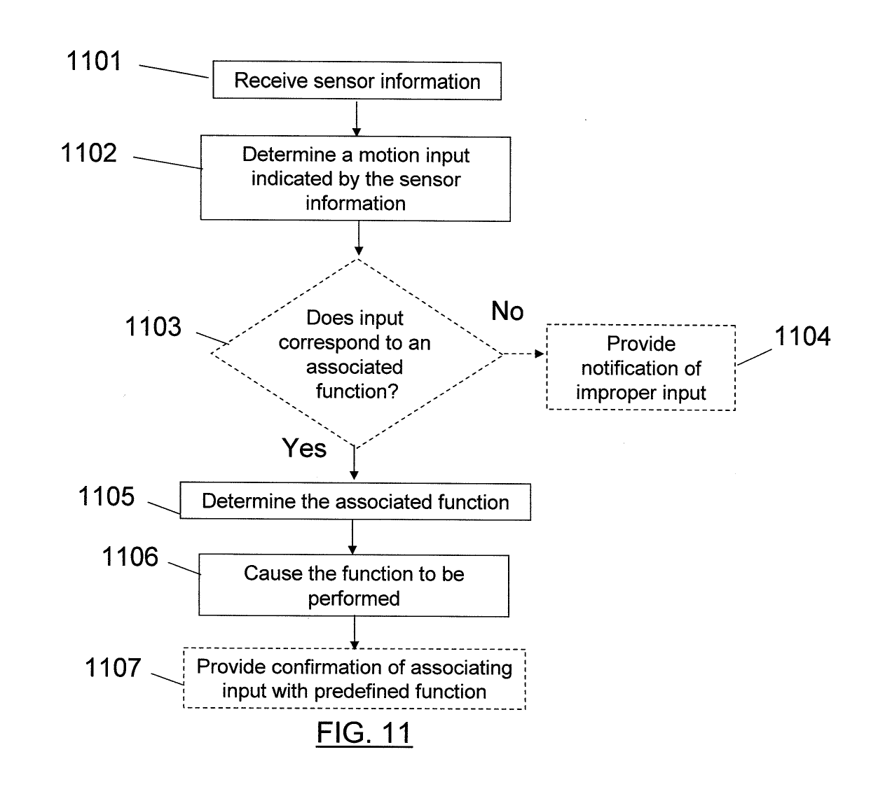

It is understood that the apparatus, such as the processor 40, may include circuitry implementing, among others, audio and logic functions of the user device 10. The processor may be embodied in a number of different ways. For example, the processor may be embodied as various processing means such as processing circuitry, a coprocessor, a controller or various other processing devices including integrated circuits such as, for example, an ASIC (application specific integrated circuit), an FPGA (field programmable gate array), a hardware accelerator, and/or the like. In an example embodiment, the processor may be configured to execute instructions stored in a memory device or otherwise accessible to the processor. As such, the processor may be configured to perform the processes, or at least portions thereof, discussed in more detail below with regard to FIG. 11. The processor may also include the functionality to convolutionally encode and interleave message and data prior to modulation and transmission. The processor may additionally include an internal voice coder, and may include an internal data modem.

The user device 10 may also comprise a user interface including an output device such as an earphone or speaker 44, a ringer 42, a microphone 46, a display 48, and a user input interface, which may be coupled to the processor 40. The user input interface, which allows the user device to receive data, may include any of a number of devices allowing the user device to receive data, such as a keypad 50, a touch display (not shown) or other input device. In embodiments including the keypad, the keypad may include numeric (0-9) and related keys (#, *), and other hard and soft keys used for operating the mobile terminal 10. Alternatively, the keypad may include a conventional QWERTY keypad arrangement. The keypad may also include various soft keys with associated functions. In addition, or alternatively, the user device may include an interface device such as a joystick or other user input interface. The user device may further include a battery 54, such as a vibrating battery pack, for powering various circuits that are used to operate the user device, as well as optionally providing mechanical vibration as a detectable output.

The user device 10 may further include a user identity module (UIM) 58, which may generically be referred to as a smart card. The UIM may be a memory device having a processor built in. The UIM may include, for example, a subscriber identity module (SIM), a universal integrated circuit card (UICC), a universal subscriber identity module (USIM), a removable user identity module (R-UIM), or any other smart card. The UIM may store information elements related to a mobile subscriber. In addition to the UIM, the user device may be equipped with memory. For example, the user device may include volatile memory 60, such as volatile Random Access Memory (RAM) including a cache area for the temporary storage of data. The user device may also include other non-volatile memory 62, which may be embedded and/or may be removable. The non-volatile memory may additionally or alternatively comprise an electrically erasable programmable read only memory (EEPROM), flash memory or the like. The memories may store any of a number of pieces of information, and data, used by the user device to implement the functions of the user device. For example, the memories may include an identifier, such as an international mobile equipment identification (IMEI) code, capable of uniquely identifying the user device. Furthermore, the memories may store instructions for determining cell id information. Specifically, the memories may store an application program for execution by the processor 40, which determines an identity of the current cell, e.g., cell id identity or cell id information, with which the user device is in communication.

In general, example embodiments of the present invention provide a method, apparatus, and computer program product for entering user input into a device through an accessory device. Devices, and particularly mobile terminals such as a cellular telephone, may use a variety of accessories intended to improve the user interface and more seamlessly integrate the device with a user's daily activities. Such devices may include wired or wireless headsets that enable a user to engage in a voice call through their device without requiring the device to be at or near the user's ear or mouth. Such accessories include Bluetooth™ headsets that may allow a user to merely be in proximity to the device while actively carrying on a conversation via the device. Such accessories may prove valuable when the user is otherwise occupied, such as when the user is driving, or performing any task that may require the use of both hands. While the wired and wireless headsets described above provide an improved method of communicating verbally via a device, initiating a voice call or activating other features of a device may still require the device to be physically manipulated.

An example embodiment of the present invention may allow the user of a device, such as user device 10, to interact with the user device without requiring physical manipulation of the device. The user input device of example embodiments of the present invention may allow a user to dial a phone number from a mobile phone, interact with services or applications available on a device, or otherwise operate a device without handling the user device itself. Such a user input device may be desirable when a user is driving a vehicle, jogging, or if the user is simply seeking an easier way to perform functions on a user device. Further, user input devices as described herein may be useful for discretely operating a user device in situations where it may be impolite or improper to physically handle, view, and operate a user device. Such situations may include meetings, formal ceremonies, during meals, at theaters, or other events where distractions are discouraged. Example embodiments of the present invention may provide a user input device that may rely on motion relative to a user to provide input to a device that is paired or synchronized with the remove user input device.

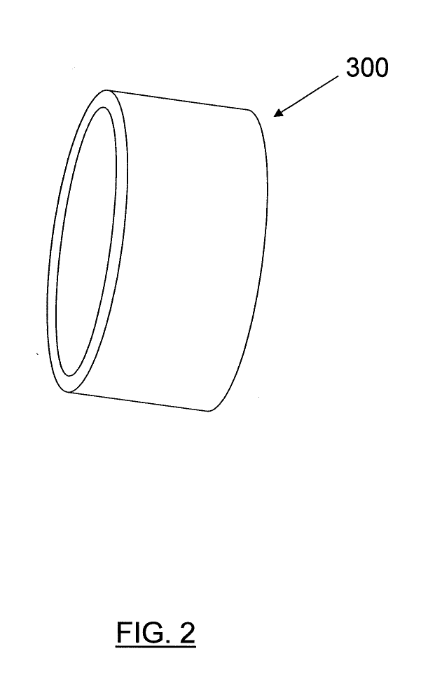

FIG. 2 illustrates a user input device according to an example embodiment of the present invention. The depicted embodiment includes an apparatus 300 that is a ring-type device configured to be worn by a user on a finger, thumb, or possibly a toe. While the illustrated embodiments are primarily directed to embodiments that may be of a ring-type, devices according to the present invention may be of a variety of shapes and sizes that are configured to be worn or attached to a user on a device-bearing part of the user. For example, a necklace-type embodiment may hang from a user's neck, an earring-type embodiment may clip or otherwise attach to a user's ear, a bracelet-type embodiment may be configured to be worn around a user's wrist, arm, leg, or ankle, and a belt-type device may be configured to be worn about a user's waist or torso. As such, example embodiments of the present invention may be configured in any number of potential configurations that permit them to be worn or otherwise attached to a user. Embodiments of the present invention may benefit from an appearance that does not substantially deviate from that of what may be a conventional ring that is worn as jewelry or ornamentation. While some example embodiments may include elements that clearly indicate the user input device is a functional device rather than strictly ornamental, other embodiments that do not clearly indicate that they are functional devices may be preferred for discretion.

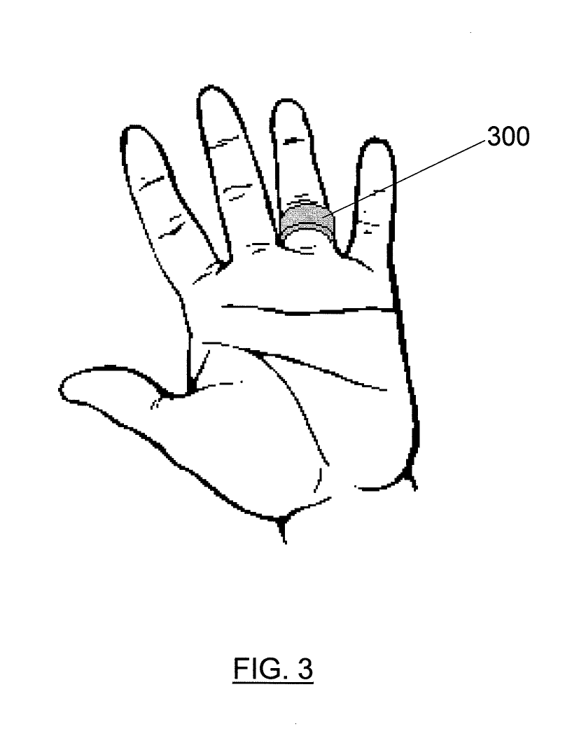

Various embodiments of the present invention may include an apparatus 300 that is configured to be worn by a user, such as on a finger as depicted in FIG. 3. The apparatus 300 may include a means for communication, such as a communication device configured for communicating via wireless Personal Area Networks (WPANs) such as IEEE 802.15, Bluetooth, low power versions of Bluetooth, infrared (IrDA), ultra wideband (UWB), Wibree, Zigbee or the like. While not shown, such a means for communication may comprise a processor, transceiver, transmitter, receiver, or the like embedded within the apparatus 300 and an antenna, in communication therewith, which may be disposed about the perimeter of the apparatus 300. The apparatus 300 may further include means for processing data (e.g., input data, sensor data, etc.) such as a processor or circuitry with the processing capabilities necessary for implementation of embodiments of the present invention.

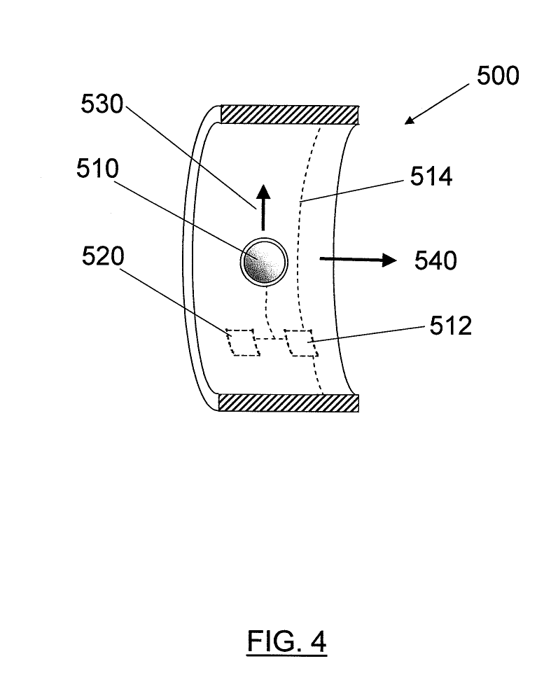

An example embodiment of the present invention is depicted in FIG. 4 which illustrates a cross-section view of a user input device 500 that may include a sensor 510, a transceiver 512, antenna 514, and a processor 520 that may provide signals to and receive signals from the transceiver, disposed within the user input device 500. The transceiver 512 and antenna 514 may be incorporated into a user input device that is configured to send or transmit a user input to a device that is wirelessly paired with the user input device; however, in embodiments where the user input device is physically connected, via electrical connection or wherein the user input device is part of the user device, the transceiver 512 and antenna 514 may not be necessary. The sensor 510 depicted illustrates a track-ball type sensor which may receive sensor information corresponding to motion of the user input device 500 in at least one direction relative to a user when the device is worn by the user. In particular, the sensor 510 may receive sensor information corresponding to rotation around a finger (e.g., along arrow 530), for example when the ring is rotated around the finger on which it is worn. The processing device 520 may function in concert with the sensor 510 to interpret the sensor information received by the sensor 510 into a motion input such that the sensor 510 itself may only transmit the motion input to the processing device 520. Optionally, the sensor may be configured with a processing device disposed therein. Further, the sensor 510 may receive sensor information corresponding to when the user input device 500 is moved along the axis of the finger (e.g., along arrow 540). The sensor 510 may also be configured to receive sensor information corresponding to motion in a combination of directions such as rotating in a first direction around a an axis extending along the length of a device bearing part of a user, for example, a finger, and then rotating about an axis that is perpendicular to the axis extending along the length of the device bearing part of the user in a rocking or oscillating motion.

The sensor information received by the sensor 510 may be determined by the processing device 520 to be a motion input that is determined to be associated with a function. The function may include transmitting or sending a command to a user device that the user input device is configured to control. A command may be an instruction such as increasing a volume, placing a call, answering a call, changing a radio station, etc. The user input device 500 may determine that the motion input is associated with a function that causes a command to be sent and subsequently cause the command to be transmitted or sent to a user device; however, the user input device may also cause only the motion input to be transmitted to a user device such that the user device associates the motion input with a function. Association between the motion input and the examples of functions that may be performed using user input devices according to an example embodiment of the present invention may include controlling a volume (e.g., a ringer volume, a call volume, a music playback volume, etc.) by, for example, rotating the ring around the finger. One direction of rotation may increase the volume while the opposite way may decrease the volume. Another function may include answering a voice call, such as when a headset is connected to the user device and the user does not or cannot physically manipulate the user device to answer the call. Any number of functions may be performed through inputs received by user input devices according to the present invention and the functions may be user configurable such that the user dictates which motions of the user input device correspond to which functions of the user device. While the number of single-stage motions (e.g., sensor information in a single direction), may be limited, single-stage motions may be multiplexed (e.g., back-and-forth sensor information) to achieve a much greater number of functions. The association between the motion input and the function may be stored in a memory at either the user device or the user input device such that either the user input device or the user device may determine the function based at least in part on the motion input received.

The sensor depicted in FIG. 4 is a track ball sensor which receives sensor information corresponding to motion of a surface over the track ball and translates the motion detected into electrical signals which are then used to determine the motion input that the track ball has observed. While a track ball is one embodiment of a sensor type that may be used within a user input device of the present invention, various other sensors may be used to achieve a similar end result. For example, the sensor 510 of FIG. 4 may be replaced or used together with an audio sensor. The audio sensor may interpret the sensor information corresponding to movement of the user input device by detecting noise that is associated with a particular type of movement. The processing device 520 may then interpret the signals detected by the audio sensor into a motion input and associate them with a function. Similarly, an optical sensor may be used to receive sensor information corresponding to the motion of the user input device with respect to the finger on which it is worn. Such a sensor may receive sensor information corresponding to a scrolling of the surface of the skin as it moves past the sensor in the case of a ring-type user input device being rotated around a finger. Similarly, the optical sensor may receive sensor information corresponding to a rocking motion by observing oscillation of the pattern observed on the surface of the skin. A rocking motion may be induced, for example in a ring-type embodiment, by a user when the user oscillates the user input device about an axis that is perpendicular to an axis along the length of the finger on which the ring-type user input device is worn. Such motion may be induced by a user rocking a thumb of the hand on which the ring is worn over the ring, or the ring may be manipulated in a rocking motion when grasped by another hand or engaged by an object (e.g., moving a hand back and forth on a surface along an axis substantially parallel to that of the finger on which the ring is worn). A further embodiment of a sensor that may be used alone or in conjunction with other sensors may be a directional-type sensor that receives sensor information corresponding to motion input in a two-dimensional plane of the sensor. In such an embodiment, a sustained press of the directional sensor in a direction in one direction may indicate a steady rotation of the ring around a finger on which it is worn. Still further embodiments of sensors that may be used in embodiments of the present invention may include multiple sensors that each track motion in separate axes, or redundant sensors that detect motion and confirm the motion observed by other sensors.

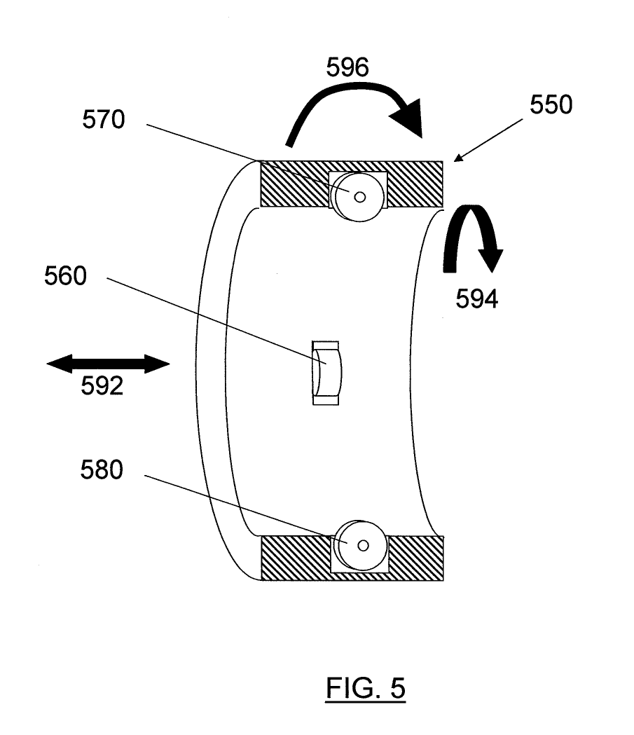

Example embodiments of the present invention may include multiple sensors that may be configured to cooperate by receiving sensor information related to movement in or about different axes or redundant sensors that receive sensor information confirm the movement observed by other sensors. An example embodiment of the present invention that includes the use of multiple sensors that cooperate to determine the movement of a user input device relative to a user is illustrated in FIG. 5 which depicts a cross-section view of a user input device 550. The user input device 550 includes wheel sensors 560, 570, and 580, that each receive sensor information regarding movement about a single axis (e.g., the hub of each respective wheel sensor). The wheels of each wheel sensor 560, 570, and 580 engage a surface of the user on the device bearing part of the user. As the user input device 550 is moved relative to a user on a device bearing part of the user, the sensors 560, 570, and 580 receive sensor information and translate the sensor information into a motion input. For example, sensor 570 may receive sensor information corresponding to motion of the user input device along an axis that extends along the length of the device bearing part of the user as it is moved along arrow 592. Sensor 560 may receive sensor information corresponding to motion around the axis that extends along the length of the device bearing part of the user, e.g., in the direction of arrow 594. Between these two sensors 560, 570, motion may be determined along or about two axes in the directions of arrows 592 and 594. Incorporating sensor 580 may allow a user input device to differentiate between the movement along arrow 592, along, for example the length of a finger, and movement in the direction of arrow 596, which is about an axis perpendicular to the axis that extends along the length of the finger. The cooperation of sensors 570 and 580 allow the user input device to receive sensor information corresponding to a rocking motion as described previously. Further, each of sensors 570 and 580 may confirm sensor information received by the other sensor as the user input device 550 is moved along arrow 592. As illustrated through the example of FIG. 5, additional sensors may enable sensor information corresponding to motion about additional axes and thereby enhance or increase the functional capabilities of a user input device according to example embodiments of the present invention.

Example embodiments of the present invention may include a sensor capable of receiving sensor information for reading a user's fingerprints such as with an optical sensor, ultrasonic sensor, passive capacitance sensor, or active capacitance sensor disposed within or on a ring-type form factor of the user input device. Such sensors may further be capable of determining a fingerprint of a wearer of the device. Example embodiments may include a security feature whereby the user input device is configured to properly function only when worn by a recognized, authorized user. An authorized user may register the fingerprint (or multiple fingerprints) with the user input device using a configuration program or wizard presented on a user device, such as a mobile terminal, and configure a fingerprint or multiple fingerprints to be used in conjunction with the user input device much in the same way a password or key-sequence may be entered on a mobile terminal to unlock the device. When such an embodiment is worn by a user that is not recognized or not authorized, the user input device may not function or may function with limited functionality.

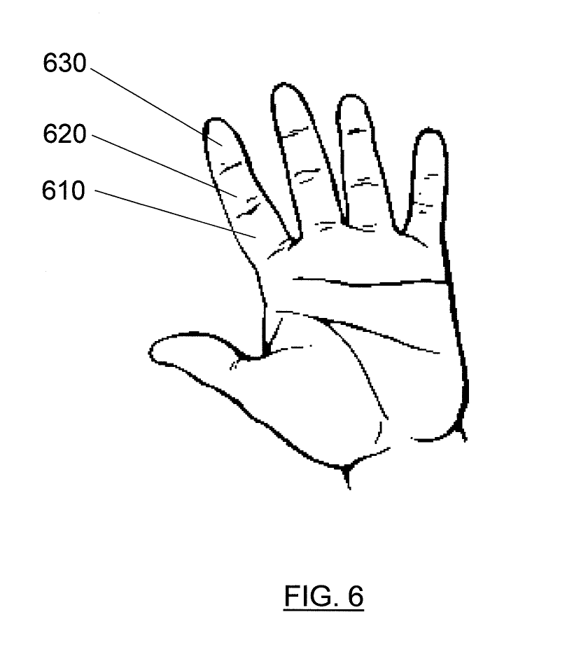

Further embodiments that may employ fingerprint-reading sensors may be configured to alter their function based upon the fingerprint observed by the user input device. Such functionality may be used to operate the user input device differently when worn by different users (e.g., users may personalize the functions of a user input device to their liking). Fingerprint recognition may also be used to alter the function of a user input device based upon where the device is worn on a user's hand. As depicted in FIG. 6, the skin surfaces of the front and back of the proximal 610, medial 620, and distal 630 phalanges of each finger include unique characteristics such that each surface of each of the phalanges can be uniquely identified based on those characteristics. The user input device may receive sensor information corresponding to these unique characteristics through a sensor as described above such that the user input device may change functions based upon the location on the hand of a user.

As the skin surfaces or fingerprints differ for each person and necessarily differ between fingers of an individual, user input devices according to example embodiments of the present invention may have a “learning” mode to learn the unique characteristics of each of the front and back surfaces of each of the phalanges of the index, middle, ring, and pinky fingers for a given user. A learning mode may require a user of the user input device to place the device on each phalange and identify on which finger and phalange they are wearing the device. A learning application may be executed by a device, such as a mobile terminal, which guides a user through the learning mode by instructing the user which finger, phalange, and surface to contact as a form of calibration. This learning mode may store fingerprint data information for a user such that when a fingerprint is obtained, the fingerprint data is compared to the fingerprint data of stored fingerprints to determine which finger and which phalange corresponds to the obtained fingerprint data. The fingerprint data information may be stored on a memory within the user input device. The fingerprint data may also or alternatively be stored in a memory of a user device that is “paired” with the user input device such that the user input device obtains the fingerprint and sends that fingerprint data to the user device for the user device to determine which finger and which phalange has been read to ascertain which functions to perform. Once a user completes such a “learning” mode, the user may be able to assign functions to any one of the surfaces of the phalanges to correspond to a function of the user device.

While embodiments of the present invention have been described herein with reference to a ring-type embodiment of a user input device, embodiments of the present invention are not limited to ring-type devices, but could be embodied in other form factors such as bracelets, buttons, or other wearable configurations that permit movement of the device relative to a wearer of the device.

User input devices according to embodiments of the present invention may be “paired” or synchronized with a user device, such as a mobile terminal (e.g., establish a unique path of communication shared only between the user input device and the user device), such as a mobile device, through a wireless Personal Area Networks such as for example Bluetooth™ connection which would prevent the user input device from interfering with other user devices and would prevent other user devices from interfering with the input of the paired user device. The “pairing” may occur at the time of manufacture if a user device is to be sold with a user input device according to embodiments of the present invention, or the “pairing” may be performed by a user in instances where the input device is sold separately as an accessory.

According to example embodiments of the user input device of the present invention, the user input device may be worn whether or not the user device is in use. In this regard, a need may exist to be able to “wake up” or unlock the input device to preclude accidental input. A sequence of movements or motions may be configured as a “wake up” sequence that is unlikely to occur accidentally. The sequence of movements or motions may be stored, for example, in a memory of a user device or the user input device such that upon detection of a sequence of movements or motions, the user device or user input device may compare the movements or motions with those required to “wake up” the device or user input device. Further, another sequence of movements or motions may be configured to lock the user input device from further input until the “wake up” sequence is given to unlock the user input device. The locking functionality may be useful for when a user is not actively using the user input device and intends for any accidental motion of the user input device that would otherwise cause an unintended input to be precluded. Such a “wake up” sequence may include rocking the user input device back-and-forth several times or rotating the user input device in a complete 360 degree turn. The “wake up” sequence may be user configurable as individual users may be more prone to certain unintended motions that would work well as “wake up” sequences for other users.

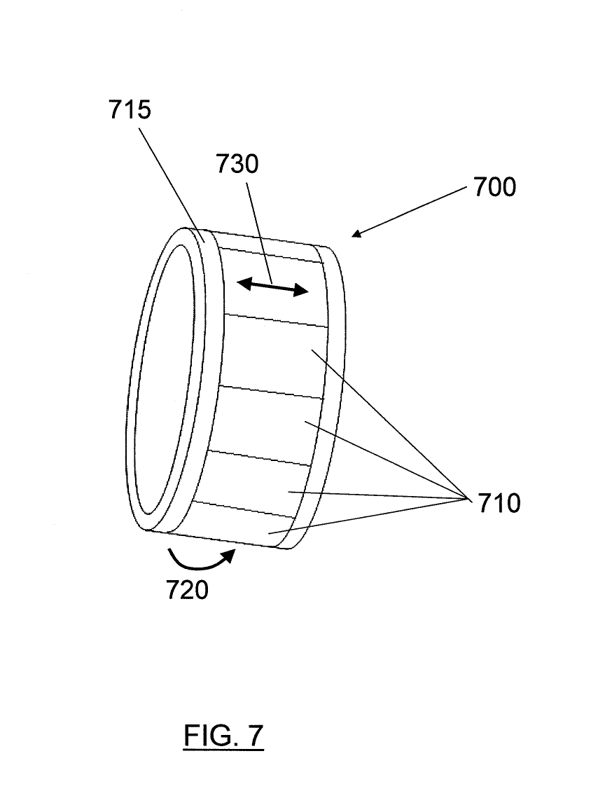

FIG. 7 illustrates another example embodiment of a user input device that may be used independently of, or in conjunction with, the example embodiments described above. The user input device 700 of FIG. 7 may include one or more sensors 710 disposed on the exterior surface of a device that may be worn by a user. The sensors may be of any conventional type known to one of ordinary skill in the art, including, but not limited to resistance touch sensors, capacitive sensors, proximity sensors, etc. In the illustrated embodiment, the user input device is a ring-type device configured to be worn on the finger of a user. The sensors 710 of the illustrated embodiment may be clearly distinguishable to a user (e.g., each sensor marked with a different symbol, number, etc.) or the sensors may be indistinguishable from the non-sensor portion of the device 715. Individually distinguishing the sensors of a user input device may be useful when each sensor is assigned a unique function or when a certain sequence of sensors is required. However, other embodiments may not require differentiation of individual sensors to achieve the desired input. Such embodiments may include wherein a user touches the sensors in a pattern, such as dragging a finger around a surface of the user input device 700. The embodiment depicted in FIG. 7 may be used in much the same way as the embodiment illustrated in FIG. 2; however, as opposed to receiving sensor information corresponding to a motion input of the user input device with respect to the finger or device bearing part of the user on which the device is worn, the user input device 700 may detect sensor information related to a touch input or motion of a user's finger, thumb or other object on the outside of the user input device 700. In such a way, the device 700 may detect sensor information corresponding to when a user is making a motion that may cause such a device to rotate, for example around a finger (e.g., sensing a finger or thumb sweeping across the periphery of the device 700 as shown with arrow 720) or the device 700 may detect sensor information corresponding to when a user is making a motion that would rock the ring back and forth (e.g., as shown with arrow 730).

The sensor information received by a sensor as depicted in the example embodiment of FIG. 7 may be used to determine a touch input. The touch input may relate to a contact with the sensor or a substantially close proximity to the sensor, for example, 1 centimeter, 1 millimeter, and/or the like. The touch input may relate to both a touch type and a touch pattern. The touch pattern may include a touch sequence (e.g., as a finger or object is dragged around the sensors 730 disposed on the periphery of the user input device 700 or a sensor 730 is tapped repeatedly) and a touch duration (e.g., how long a sensor detects the touch information). The touch type may include the number of contact points or simultaneous touches detected, the location of the multiple touches, physical properties associated with the object sensed by the sensors, whether the touch input relates to contact, whether the touch input relates to close proximity, force with which the sensors are touched, etc. Differentiating touch types and touch patterns may increase the number of potential touch inputs available to associate with different functions. For example, when the user input device 700 of FIG. 7 receives sensor information from two or more touch points (e.g., a multiple-point touch), there may be a higher likelihood that the touch input is received from the opposing hand or a hand on which the user input device 700 is not worn. When the user input device 700 receives sensor information from only a single point (e.g., a single-point touch), the touch could be from either a hand on which the user input device is worn or from another source. Such a touch type may differentiate the touch input as being from a different hand and thus cause a different function to be performed. Touch patterns, as noted above, may include multiple taps of a single sensor, a sequence of adjacent sensors receiving sensor information corresponding to a touch as a finger is dragged across them, or a length of touch or touches among other patterns. Each touch pattern may be associated with a different function and may allow for a variety of inputs to be used based upon the touch type or pattern received. These various touch types and touch patterns may be stored, for example, in a memory on the user input device or on the user device such that upon the user input device receiving a touch input relating to a touch pattern and a touch type, the received touch input is compared by, for example, the processor, with touch inputs that are in the memory to determine which function they may be associated with. Combining touch patterns, touch types, or both, may further increase the number of available inputs and further increase the level of functionality that may be achieved with user input devices 700 according to example embodiments of the present invention.

The example embodiment of FIG. 7, or variations thereof, may be configured to receive sensor information corresponding to surface texture and/or surface color based upon the type of sensors used to discern a touch type related to the touch input. A sensor that acts as a color-spectrometer may receive sensor information corresponding to different color surfaces and may construe each different color encountered by the sensor as a separate and distinct touch type. Other sensors that may be used in an embodiment similar to that illustrated in FIG. 7 may receive sensor information corresponding to a texture or type of surface with which the device is brought into contact. Such a sensor may include an optical sensor that detects surface texture or a resistance sensor that detects the conductive properties of the surface with which the sensor is brought into contact. Further sensor types may include a frequency sensor that may receive sensor information corresponding to the frequency of vibratory response when a sensor is struck against a surface. The frequency detected may differentiate between wood, glass, stone, and the like and provide differentiate touch type from said surfaces. A variety of sensors may be used on a single user input device to further enhance the input capabilities of such a device. A touch type may include the number of points of contact or touch detected and a touch type may also include the type of object or surface touching the sensor (e.g., a physical property of the object or surface such as color, texture, hardness, etc.). The user input device or the user device may store associations between touch inputs and functions such that a processing device can determine a function based at least in part on the touch input. After determining that the appropriate function based on the touch input, the user device or the user input device may cause that function to be performed. Causing the function to be performed may include causing the user input device to transmit a command to a user device.

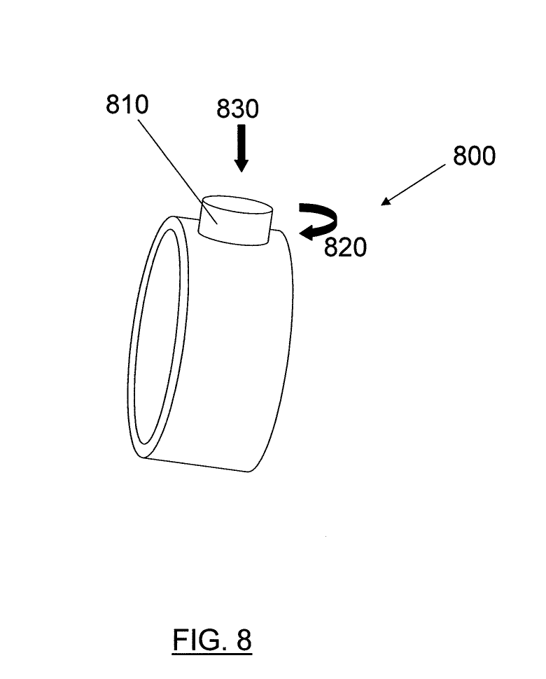

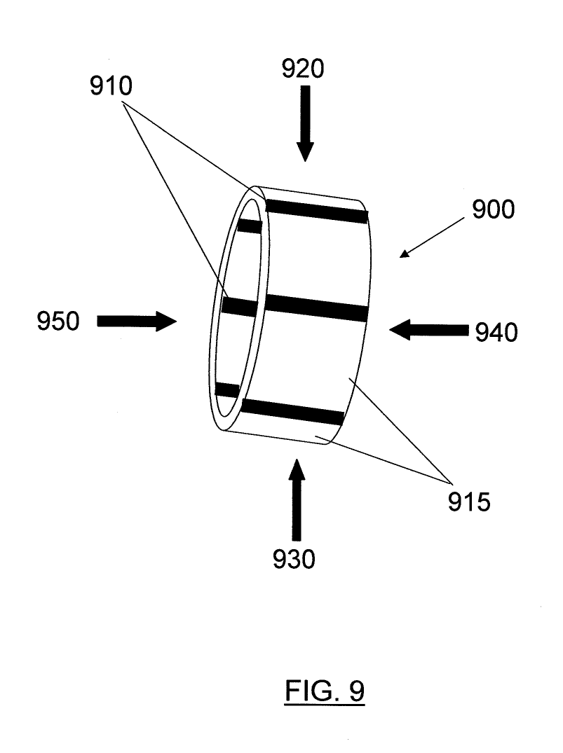

FIGS. 8, 9, and 10 depict three example embodiments of sensor configurations that may be implemented in embodiments of the present invention. The configurations illustrated in FIGS. 8-10 may be used independent of, or in conjunction with any of the embodiments disclosed herein. FIG. 8 depicts a ring-type user input device 800 that includes an input sensor 810 that may be configured as a touch sensitive sensor, a rotary dial, a push button, or any possible combination thereof For example, in such an embodiment where sensor input 810 is a rotary dial, the rotary dial may be turned along arrow 820 as a method of input. In a push-button type embodiment, the sensor 810 may be depressed along arrow 830. Both of these embodiments may be used in concert to achieve a higher level of functionality. FIG. 9 depicts an embodiment including a ring-type user input device 900 that may be deformable, for example when squeezed between arrows 920 and 930. The amount of deformation and the direction of the deformation may serve to differentiate the input for multi-mode functionality. An embodiment similar to FIG. 9 may also be deformable between arrows 940 and 950. The ability of the device to be deformed may lie in material properties of the entire device, or the device may include deformable portions such as 910 between substantially non-deformable portions 915. Stress or strain sensors may be disposed in the deformable portions of the device such that the level of stress or strain may be interpreted as the input.

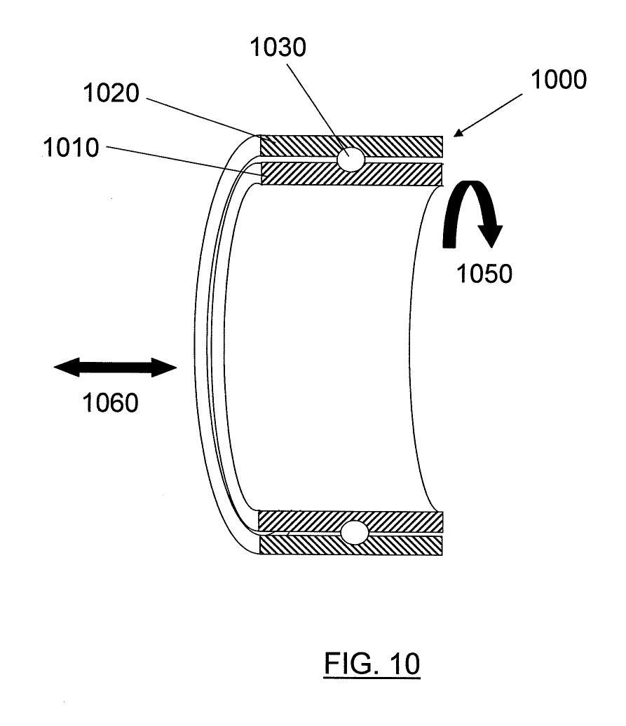

FIG. 10 depicts a cross-sectional view of a further example embodiment of a sensor configuration that may be used in connection with embodiments of the present invention. The depicted embodiment illustrates a ring-type user input device 1000 that includes an inner ring or inner race 1010 and an outer ring or outer race 1020. The outer ring riding on bearings 1030 that are disposed in bearing grooves on both the inner and outer races 1010, 1020. Sensors may be disposed on either or both of the inner race 1010 and outer race 1020 to receive sensor information corresponding to relative motion therebetween along arrow 1050. The relative motion may be used as an input as described with regard to the sensor arrangements above. Further relative motion between the inner race 1010 and outer race 1020 may be discerned by sensors disposed therebetween when the outer race 1020 is moved axially relative to the inner race 1010 along arrow 1060.

Example embodiments of the present invention may further be configured to receive sensor information from both motion and touch such that the user input device is capable of both a touch input and a motion input. For example, embodiments such as the embodiment of FIGS. 4 and 5 could be combined with the embodiments of FIG. 7, 8, 9, or 10. A user input device configured for both touch inputs and motion inputs may be configured to sense both motion relative to a user, such as along the length of a device bearing part of a user, and the user input device may further be configured to sense a touch of the user input device by a user or object. Combining touch input capability with motion input capability may further enhance the number of inputs, both single-mode and multi-mode, such that a greater number of functions can be caused to be performed.

The functions associated with each of the available touch inputs or motion inputs of a user input device according to example embodiments of the present invention may be user-configurable such that the user can select the desired function that each different input performs. Further, with the aid of multiplexing single-mode inputs, the user may configure a large multitude of functions with only a limited number of available inputs. The functions may be user device dependent such that a user input device may be configured to operate with multiple user devices and with each device, a different set of functions may be used. For example, if the user input device is “paired” with a mobile phone, the available functions may correspond to inputs related to answering, ignoring, or silencing a phone call. If the user input is “paired” with a music player device, an alternative set of functions may be available that includes pause, play, volume, fast-forward, and reverse among other inputs.

As user devices often have multiple functions, such as a mobile phone that is also a music player device, the user input device may be capable of switching between sets of functions based upon the active application of a user device. For example, while the mobile device is in a music playback mode, the user input device may function with the music player controls described above. If the user device is in a phone call mode, for example with a Bluetooth™ headset, the user input device may operate with a separate set of functions related to the phone call functionality.

User input devices according to example embodiments of the present invention may be further configured such that a user may associate each available motion input or touch input to a function. The user may enter a learning or set-up mode in which the user may touch or move the user input device to provide sensor information corresponding to a motion input or a touch input. The user may then choose a function to which they wish to generate an association to the motion input or touch input with. The motion input or touch input association with the function may be stored such that when the user replicates the motion or touch that corresponds to the motion input or touch input, the appropriate function is determined based at least in part on the motion input or the touch input.

Additionally, the functions of the user input device may be switched by the user device without user input in instances such as when a user is listening to music and the music player functions are active and a phone call is received by the user device. The user device may cause the user input device to switch from the music player mode to the phone function mode. Optionally, there may be a separate set of functions that corresponds to an incoming phone call during music player mode in which abbreviated functions or phone call specific functions are available to a user, such as “answer” and “ignore” among other possible functions.

As a display may not be visible for a user device while operating a user input device according to embodiments of the present invention, the user input device may be configured to provide non-visual feedback to a user to confirm that an instruction was received when the user input device receives an input. Such non-visual feedback may be in the form of an audible tone or a vibratory response from the user device, the user input device, or another accessory such as a headset worn by the user.

A flowchart illustrating operations performed by a user input device of FIGS. 2-9 and/or the user device of FIG. 1 is presented in FIG. 11. It will be understood that each block of the flowcharts, and combinations of blocks in the flowchart, may be implemented by various means, such as hardware, firmware, processor, circuitry and/or other device(s) associated with execution of software including one or more computer program instructions. For example, one or more of the procedures described above may be embodied by computer program instructions. In this regard, the computer program instructions which embody the procedures described above may be stored by a memory device 60, 62 of an apparatus employing an example embodiment of the present invention and executed by a processor 40 in the apparatus. As will be appreciated, any such computer program instructions may be loaded onto a computer or other programmable apparatus (e.g., hardware), such as depicted in FIG. 1, to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, can be implemented by special purpose hardware- based computer systems which perform the specified functions, or combinations of special purpose hardware and computer instructions. The function of each operation of the flowcharts described herein may be performed by a processor bringing about the operation or transformation set forth in the flow chart operations. Blocks of the flowcharts and flowchart elements depicted in dashed lines may be optional operations that can be omitted from example embodiments of the present invention.

A method according to an example embodiment of the present invention is illustrated in the flowchart of FIG. 11 in which means, such as at least one sensor of a user input device receives sensor information at 1101. The sensor information received may include an indication of the movement of a device bearing part of a user relative to a sensor (and hence the user input device), such as a track-ball sensor, an electrostatic sensor, a wheel sensor, or an optical sensor among various other sensors described above with respect to example embodiments. The motion input indicated by the received sensor information is determined at 1102. Means for determining the motion input indicated may include a processing device, such as processor 510 of FIG. 4. The determination is made at 1103 whether or not the motion input corresponds to an associated function. For example, the user input device and/or the user device may include means, such as the processor 510 and/or the processor 40 for determining whether or not the motion input determined from the sensor information received by the sensor means corresponds to an associated function. If no function is associated with the motion input, a means may be provided for providing an audible, visual, or tactile notification of an improper motion input may be provided by either the user device or the user input device at 1104. The means may include a speaker 44 for audible feedback, a vibration element to provide vibratory response, a display 48 for providing a visual notification, or any such means for providing audible, tactile, or visual feedback. If a function is associated with the motion input determined at 1102, that function is determined at 1105, for example by processor 510 or 40 and at 1106 the function is caused to be performed. For example, a device may perform the function by communication means such as via a wireless signal over a wireless communications network. The function may include causing a command to be sent to another device, such as a mobile terminal or other device that is in communication with the user input device. A confirmation of associating the input with a predefined function may be given at 1107 in the form of an audible, visual, or tactile signal by any such means as described previously.

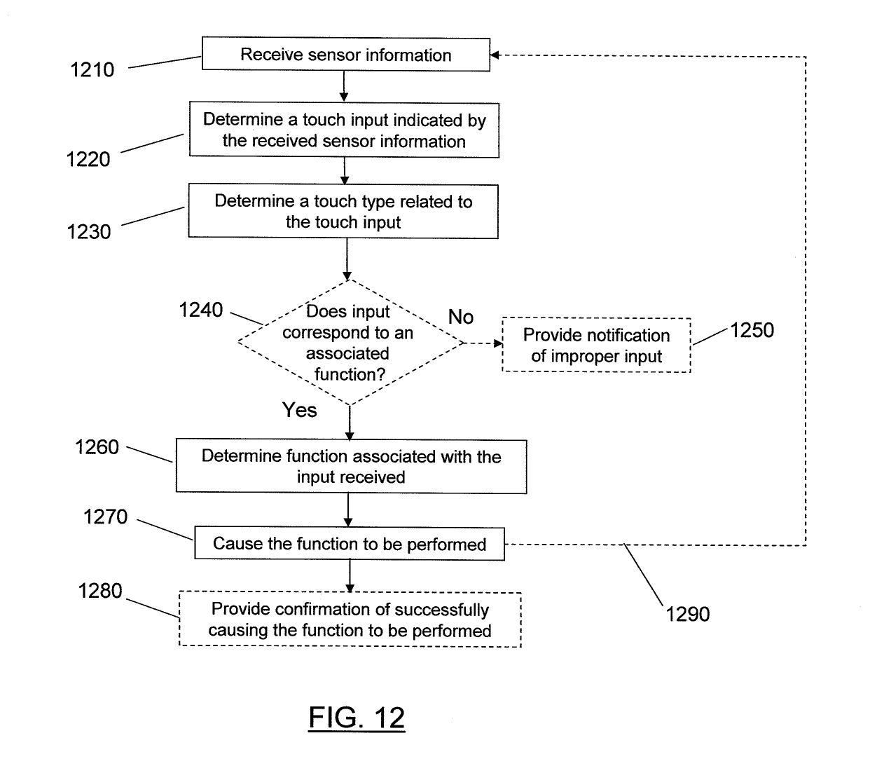

Another method according to an example embodiment of the present invention is illustrated in the flowchart of FIG. 12 in which sensor information of a device configured to be worn by a user are received at 1210 by means, such as a sensor (e.g., electrostatic sensor, capacitive sensor, optical sensor, track-ball sensor, etc.). A touch input indicated by the sensor information received is determined at 1220, by means such as a processing device that may receive the sensor information. A touch type related to the touch input is determined at 1230. The touch type may include a number of simultaneous touch points (e.g., single-point touch, multiple-point touch), a touch color, a touch hardness (e.g., the hardness of an object that touched the user input device), a touch velocity, etc. The touch type may be determined by means such as a processing device which may receive the sensor information and determine the touch type. If the touch input corresponds to an associated function (e.g., it is determined that an association exists between the touch input and a function stored in a memory) at 1240, the associated function is determined at 1260, by means such as a processing device. If no function is determined to be associated with the touch input at 1240, a notification may be provided at 1250 that indicates to a user that the touch input was invalid. The notification may include audio, visual, or tactile feedback as described above. After determining the function associated with the touch input at 1260, the function may be caused to be performed at 1270. Causing the function to be performed may include providing for transmission of a command to a user device or causing a command to be performed, such as an instruction for an application on a user device. Means for causing the function to be performed may include a processing device and/or a transponder associated with a processing device. At 1280, a confirmation of successfully causing the function to be performed may be given, such as through an audible, visual, or tactile feedback. 1290 illustrates the path taken when a second sensor information is received at 1210. Upon receiving the second sensor information, the process repeats beginning with determining a touch input indicated by the second received sensor information at 1220. A second touch type related to the second touch input may be determined at 1230. At 1240 it is determined whether the second touch input corresponds with a stored, associated function. Provided the second touch input relating to the second touch type is associated with a stored function, the function is determined at 1260 and that second function is caused to be performed at 1270. The second function is determined based at least in part on the second touch input which relates to the second touch type.

Embodiments of the present invention may be configured as a system, method or electronic device. Accordingly, embodiments of the present invention may be comprised of various means including entirely of hardware or any combination of software and hardware. Furthermore, embodiments of the present invention may take the form of a computer program product on a computer-readable storage medium having computer-readable program instructions (e.g., computer software) embodied in the tangible, non-transitory storage medium. Any suitable computer-readable storage medium may be utilized including hard disks, CD-ROMs, optical storage devices, or magnetic storage devices.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and associated drawings describe example embodiments in the context of certain example combinations of elements and/or functions, it should be appreciated that different combinations of elements and/or functions may be provided by alternative embodiments without departing from the spirit and scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving sensor information of a device configured to be worn by a user;
determining a motion input indicated by the received information, wherein the motion input relates to motion of the device relative to the user;
determining a function based at least in part on the motion input; and
causing the function to be performed.

2. A method according to claim 1, wherein the device is configured to be worn on a device bearing part of the user and the motion input relates to motion of the device relative to the device bearing part of the user.

3. A method according to claim 2, wherein the device bearing part of the user is a finger and wherein the device substantially encircles the finger.

4. A method according to claim 2, wherein the motion input includes at least one of axial movement along a first axis which extends along the length of the device bearing part of the user rotational movement about the first axis, or rotational movement about a second axis that is perpendicular to the first axis.

5. A method according to claim 2, wherein the motion input is detected using a sensor disposed on an inner surface of the device and wherein the inner surface comprises a surface that is in contact with the device bearing part of the user.

6. A method according to claim 1, further comprising learning the motion input by a learning process comprising:
receiving a motion input from the user, wherein the motion input causes a motion of the device relative to the user;
causing the motion input to be stored; and
associating the motion input with a function.

7. A method according to claim 1, wherein the function comprises causing a command to be sent to another device.

8. An apparatus comprising at least one processor and at least one memory including computer program code, the at least one memory and the computer program code configured to, with the at least one processor, cause the apparatus to at least perform:
receive sensor information of a device configured to be worn by a user;
determine a motion input indicated by the received information, wherein the motion input relates to motion of the device relative to the user;
determine an function based at least in part on the motion input; and
causing the function to be performed.

9. An apparatus according to claim 8, wherein the device is configured to be worn on a device bearing part of the user and the motion input relates to motion of the device relative to the device bearing part of the user.

10. An apparatus according to claim 9, wherein the device bearing part of the user is a finger and wherein the device substantially encircles the finger.

11. An apparatus according to claim 9, wherein the motion input includes at least one of axial movement along a first axis which extends along the length of the device bearing part of the user, rotational movement about the first axis, or rotational movement about a second axis that is perpendicular to the first axis.

12. An apparatus according to claim 9, wherein the motion input is detected using a sensor disposed on an inner surface of the device and wherein the inner surface comprises a surface that is in contact with the device bearing part of the user.

13. An apparatus according to claim 8, wherein the at least one memory and the computer program code are further configured to, with the at least one processor, cause the apparatus to:
receive a motion input from the user, wherein the motion input causes a motion of the device relative to the user;
cause the motion input to be stored; and
associate the motion input with a function.

14. An apparatus according to claim 8, wherein the function comprises causing a command to be sent to another device.

15. A computer program product comprising at least one computer-readable storage medium having computer-executable program code instructions stored therein, the computer-executable program code instructions comprising:
program code instructions for receiving sensor information of a device configured to be worn by a user;
program code instructions for determining a motion input indicated by the received information, wherein the motion input relates to motion of the device relative to the user;
program code instructions for determining a function based at least in part on the motion input; and
program code instructions for causing the function to be performed.

16. A computer program product according to claim 15, wherein the device is configured to be worn on a device bearing part of the user and the motion input relates to motion of the device relative to the device bearing part of the user.

17. A computer program product according to claim 16, wherein the device bearing part of the user is a finger and wherein the device substantially encircles the finger.

18. A computer program product according to claim 16, wherein the motion input includes at least one of axial movement along a first axis which extends along the length of the device bearing part of the user, rotational movement about the first axis, or rotational movement about a second axis that is perpendicular to the first axis.

19. A computer program product according to claim 16, wherein the motion input is detected using a sensor disposed on an inner surface of the device and wherein the inner surface comprises a surface that is in contact with the device bearing part of the user.

20. A computer program product according to claim 15, wherein the computer-executable program code instructions further comprise:
program code instructions for receiving a motion input from the user, wherein the motion input causes a motion of the device relative to the user;
program code instructions for causing the motion input to be stored; and
program code instructions for associating the motion input with a function.
